(19) United States
(12) Patent Application Publication
(10) Pub. No.: US 2012/0208446 A1
(43) Pub. Date: Aug. 16, 2012

(54) HVAC SYSTEM FOR A WORK VEHICLE

(76) Inventors: Lance A. TAYLOR, Wichita, KS (US); Alan G. Leupold, Plainfield, IL (US)

(21) Appl. No.: 13/220,250

(22) Filed: Aug. 29, 2011

Related U.S. Application Data
(60) Provisional application No. 61/463,061, filed on Feb. 11, 2011.
(60) Provisional application No. 61/463,059, filed on Feb. 11, 2011.
(60) Provisional application No. 61/463,112, filed on Feb. 11, 2011.

(51) Int. Cl. B60H 1/00

(52) U.S. Cl. 454/158

(57) ABSTRACT

An HVAC system for a work vehicle having an operator cab including a system positioned substantially within the cab behind and below an operator's chair. A portion of the system has at least one inlet, and a plurality of outlets positioned in front of the operator's chair. The system includes a filter configured to be easily maintained in its substantially horizontal position during removal so that debris retained on the upper surface of the filter does not fall into a portion of the HVAC system or the cab when the filter is removed therefrom.

### RELATED APPLICATION

This application claims priority to U.S. Provisional Patent Application Ser. No. 61/463,061, filed Feb. 11, 2011, entitled “Conveniently Located Debris Contained HVAC Filter Serviceability”, which application is hereby incorporated by reference in its entirety. This application claims priority to U.S. Provisional Patent Application Ser. No. 61/463,059, filed Feb. 11, 2011, entitled “Foreign Matter HVAC Ingestion Mitigation Labyrinth”, and to U.S. Nonprovisional patent application Ser. No. 13/116,495, filed May 26, 2011, entitled “HVAC System For A Work Vehicle”, which applications are hereby incorporated by reference in their entirety. This application claims priority to U.S. Provisional Patent Application Ser. No. 61/463,112, filed Feb. 11, 2011, entitled “Circulating Airflow Rear Window Defroster”, and to U.S. Nonprovisional patent application Ser. No. 13/116,050, filed May 26, 2011, entitled “HVAC System For A Work Vehicle”, which applications are hereby incorporated by reference in their entirety.

### FIELD OF THE INVENTION

The present invention generally relates to HVAC systems and, more particularly, to an HVAC system for use with an operator cab of a work vehicle.

### BACKGROUND OF THE INVENTION

A work vehicle, such as a skid steer or wheel loader is commonly used to load and move substantial volumes of dirt and like material from one location to another. A conventional wheel loader includes a relatively large frame that is supported for self-propelled movement over land by pairs of air-filled pneumatic tires or tracks and has a bucket or implement mounted to one end thereof. The bucket or implement can be selectively elevated to a position above side panels on a wheel loader and can be selectively tilted to “dump” materials therefrom.

To enhance operator comfort, a heating, ventilation and air conditioning (HVAC) system can be incorporated into an operator cab. However, filters associated with the HVAC systems in conventional work vehicles are typically arranged such that removal of the filters is a difficult, labor-intensive task, and that the filters are typically positioned in or near the roof of the cab and must be accessed from exterior of the cab. In addition, due to the elevated vertical position of the filter, difficulty associated with installation/removal is further increased. Moreover, the filter is often arranged such that during filter replacement, particulate matter that has accumulated in and/or on the filter cannot be removed without spilling a significant portion of the particulate matter in a portion of the HVAC system or the cab. Debris from the filter which falls into fans, motors, condensers, conduits, and so forth, may interfere or clog these apparatus, resulting in breakdown of the HVAC system. Further, debris which falls into the cab may result in recirculation of the debris within the air, resulting in poor air quality for the operator. Further debris falling from the filter into the cab may result in a mess that requires subsequent cleaning of the cab, as well as the hands and/or clothing of the maintenance personnel.

Thus, there is a need and a desire for an HVAC system for use in a work vehicle that is easily accessible and which can be removed without spilling the particulate matter collected by the filter being replaced.

### SUMMARY OF THE INVENTION

Other features and advantages of the present invention will be apparent from the following more detailed description of the preferred embodiment, taken in conjunction with the accompanying drawings which illustrate, by way of example, the principles of the invention.

The present invention relates to an HVAC system for a work vehicle having an operator cab including a system positioned substantially within the cab behind and below an operator's chair. A portion of the system has at least one inlet, and a plurality of outlets are positioned in front of the operator's chair. The system includes a chamber positioned in the interior of the cab and behind an operator's chair, the chamber having a first inlet for receiving an exterior airflow from outside of the cab. The chamber has a second inlet for receiving an interior recirculated airflow from air contained within the cab, the chamber mixing the exterior airflow with the interior recirculated airflow to form a mixed airflow which is directed substantially vertically downward out of a chamber outlet. A filter is positioned in a conduit connected to the chamber outlet and in fluid communication with the chamber, the first inlet, the second inlet, and the plurality of outlets. The filter is positioned below the chamber in a substantially horizontal position relative to the substantially mixed airflow flowing through the chamber to an upper surface of the filter. The substantially vertical mixed airflow moves through the filter and through the plurality of outlets in the HVAC system such that airflow from the plurality of outlets circulates over and around the operator's chair, providing a generally circular path of airflow about the operator's chair. At least a portion of the circular airflow re-enters the chamber as interior recirculated airflow. The filter is configured to trap debris from the vertical mixed airflow via its orientation and the filter is configured for easy removal by an operator inside of the cab. The filter is configured to be easily maintained in its substantially horizontal position during removal so that debris retained on the upper surface of the filter does not fall into a portion of the HVAC system or the cab when the filter is removed therefrom.

The present invention further relates to a work vehicle including a motor secured to a frame for activating a driving device for selectably moving the frame. An operator cab is supported by the frame. An HVAC system for a work vehicle having an operator cab includes a system positioned substantially within the cab behind and below an operator's chair. A portion of the system has at least one inlet, and a plurality of outlets are positioned in front of the operator's chair. The system includes a chamber positioned in the interior of the cab and behind an operator's chair, the chamber having a first inlet for receiving an exterior airflow from outside of the cab. The chamber has a second inlet for receiving an interior recirculated airflow from air contained within the cab. The chamber mixes the exterior airflow with the interior recirculated airflow to form a mixed airflow which is directed substantially vertically downward out of a chamber outlet. A filter is positioned in a conduit connected to the chamber outlet and in fluid communication with the chamber, the first inlet, the second inlet, and the plurality of outlets. The filter is positioned below the chamber in a substantially horizontal position relative to the substantially mixed airflow flowing through the chamber to an upper surface of the filter. The substantially vertical mixed airflow moves through the filter and through the plurality of outlets in the HVAC system such that airflow from the plurality of outlets circulates over and around the operator's chair, providing a generally circular path of airflow about the operator's chair. At least a portion of the circular airflow re-enters the chamber as interior recirculated airflow. The filter is configured to trap debris from the vertical mixed airflow via its orientation and the filter is configured for easy removal by an operator inside of the cab. The filter is configured to be easily maintained in its substantially horizontal position during removal so that debris retained on the upper surface of the filter does not fall into a portion of the HVAC system or the cab when the filter is removed therefrom.

The present invention yet further relates to a work vehicle including a motor secured to a frame for activating a driving device for selectably moving the frame. An operator cab is supported by the frame. An HVAC system for a work vehicle having an operator cab includes a system positioned substantially within the cab behind and below an operator's chair. A portion of the system has at least one inlet, and a plurality of outlets positioned in front of the operator's chair. The system includes a chamber positioned in the interior of the cab and behind an operator's chair, the chamber having a first inlet for receiving an exterior airflow from outside of the cab. The chamber has a second inlet for receiving an interior recirculated airflow from air contained within the cab, the chamber mixing the exterior airflow with the interior recirculated airflow to form a mixed airflow which is directed substantially vertically downward out of a chamber outlet. A filter is positioned in a conduit connected to the chamber outlet and in fluid communication with the chamber, the first inlet, the second inlet, and the plurality of outlets. The filter is positioned below the chamber in a substantially horizontal position relative to the substantially mixed airflow flowing through the chamber to an upper surface of the filter. The substantially vertical mixed airflow moves through the filter and through the plurality of outlets in the HVAC system such that airflow from the plurality of outlets circulates over and around the operator's chair, providing a generally circular path of airflow about the operator's chair. At least a portion of the circular airflow re-enters the chamber as interior recirculated airflow. The filter is configured to trap debris from the vertical mixed airflow via its orientation and is configured for easy removal by an operator inside of the cab. The filter is configured to be easily maintained in its substantially horizontal position during removal so that debris retained on the upper surface of the filter does not fall into a portion of the HVAC system or the cab when the filter is removed therefrom. A sufficient portion of the chamber is manually removable to permit removal of the filter.

An advantage of the present invention is an HVAC system that is easily accessible and which can be removed without spilling the particulate matter collected by the filter being replaced.

Numerous other features and advantages of the present invention will become readily apparent from the following detailed description, the accompanying drawings, and the appended claims.

### BRIEF DESCRIPTION OF THE DRAWINGS

FIG. 1 is a forward-looking upper perspective view of an exemplary embodiment of a work vehicle including an HVAC system of the present disclosure;

FIG. 2 is a cross section taken along line 2-2 of FIG. 1 of the present disclosure;

FIG. 3 is a cross section taken along line 3-3 of FIG. 1 of the present disclosure;

FIGS. 4-6 are front views showing different stages of assembly of the HVAC system of the present disclosure;

FIG. 7 is a cross section taken along line 7-7 of FIG. 3 of the present disclosure; and

FIG. 8 is a perspective view of an exemplary embodiment of a filter of the present disclosure.

### DETAILED DESCRIPTION OF THE INVENTION

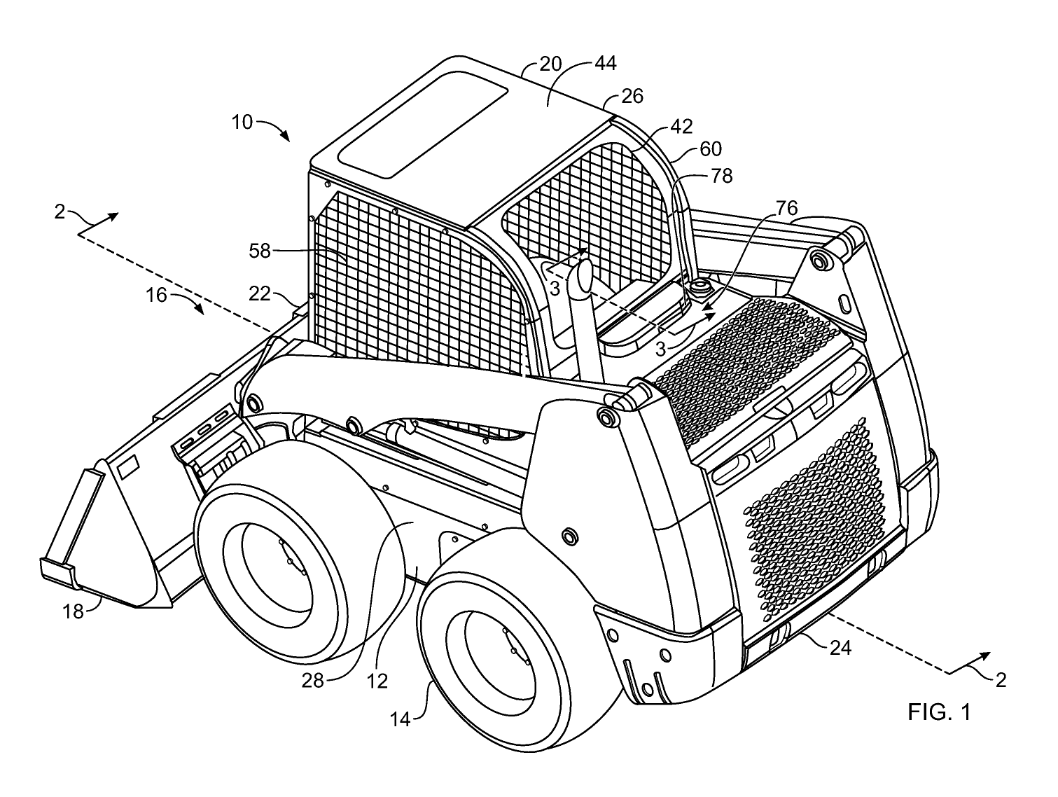

FIG. 1 shows a work vehicle 10 provided with a frame 12 that rotatably carries a driving device 14, such as a plurality of wheels, although in another embodiment, tracks may be used or activated to selectably move the vehicle. A lifting structure 16 includes an arrangement of structural members and actuators controllable by an operator (not shown) to manipulate an implement 18 to perform work. Frame 12 structurally supports an operator cab 20 or cab to surround and protect the operator, which frame 12 includes a front end 22 facing implement 18 and an opposed back end 24 with ends 22, 24 positioned between opposed lateral sides 26, 28 of the frame.

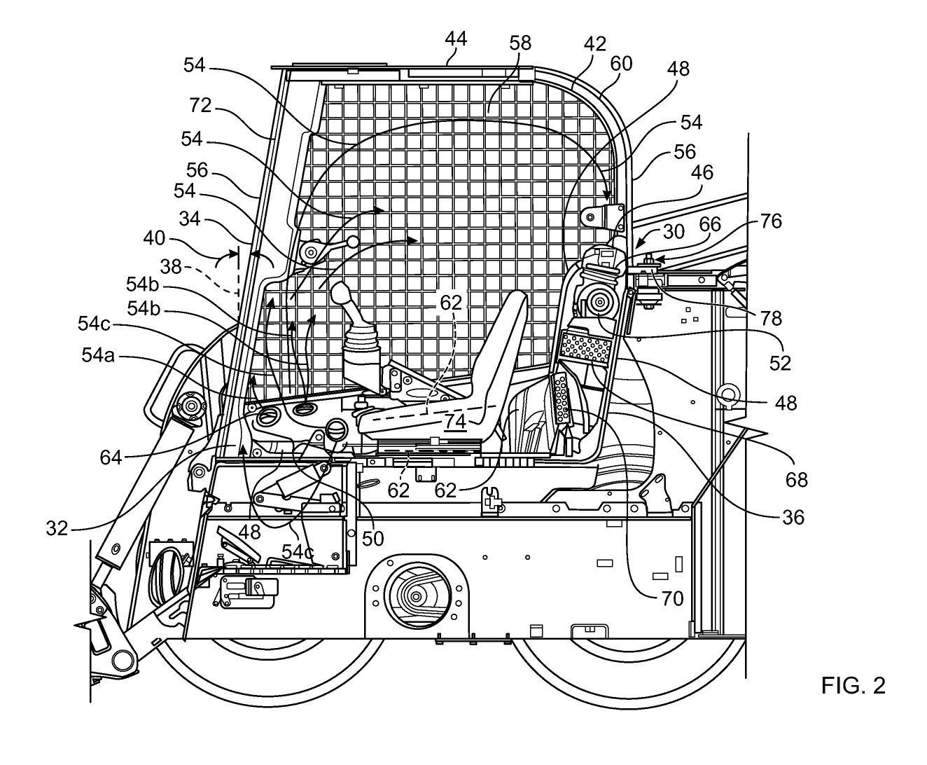

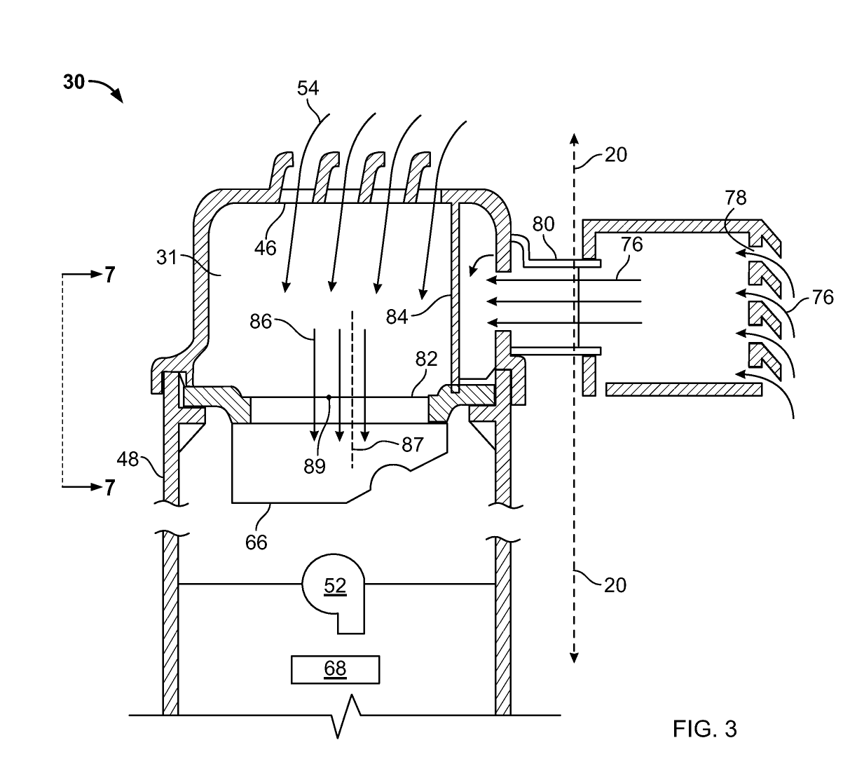

FIGS. 2-3 show different views of cab 20 and associated structure. Cab 20 includes an HVAC system 30 to provide environmental comfort to an operator positioned within the cab. In addition, HVAC system 30, in combination with unique structural features of cab 20, provides a flow of recirculating air 54 from within cab 20 in combination with a flow 76 of ambient air exterior of the cab that is sufficient to remove a non-transparent layer 56 of a phase of evaporable matter forming on a surface of a forward viewing region 34, a rear viewing region 42 and side viewing regions 58. For purposes of the disclosure, circulating air or circulating airflow as well as recirculating flow and recirculating airflow or the like may be used interchangeably. The HVAC system 30 is desirably at least partially contained within an interior of a cab. Of The phrase “partially contained” as used herein means at least about 50 percent or more contained within the cab 20. More desirably, the HVAC system 30 is substantially contained within an interior of the cab 20. “Substantially contained” as used herein means at least about 90 percent or more contained within the cab 20.

Cab 20 includes a forward portion 32 for supporting a forward viewing region 34, such as a substantially transparent door, which not only provides an operator with enhanced viewing capability, but also providing an enclosure so that HVAC system 30 may be utilized to provide environmental comfort to the operator. Side viewing region 58 extends from forward portion 32 to rear portion 36 of the cab 20. In one embodiment, side viewing region 58 is composed of a substantially transparent material, such as tempered glass, to provide operator viewing capability, while also providing an enclosure for operator comfort. Cab 20 has a rear portion 36 that includes a rear viewing region 42, provided for similar reasons as the forward viewing region 34 and side viewing regions 58.

Forward viewing region 34 is oriented at an angle 40 with respect to a vertically directed line 38. As shown in FIG. 2, angle 40 is upwardly sloped toward rear portion 36. As further shown in FIG. 2, forward viewing region 34 is substantially planar, although in another embodiment the forward viewing region may include a curved profile so the angle between a vertically directed line 38 and its forward viewing region may vary, but will generally define an acute angle between the forward viewing region 34 and rear viewing region 36. With forward viewing region 34 of 20 having a planar profile and a substantially horizontal top 44, the forward viewing region and top form an obtuse angle therebetween. Additionally, as shown in FIG. 2, side viewing regions 58 are substantially planar, although in another embodiment the side viewing regions may include a curved profile.

In contrast to forward viewing region 34 and side viewing regions 58, rear viewing region 42 that extends between top 44 and rear portion 36 of the cab includes a significant curved profile. Curved cab structure 60 is provided to effectively provide lateral support to rear viewing region 42. Additionally, by virtue of the radius of curvature of cab structure 60 being substantially the same as the radius of curvature of rear viewing region 42, curved cab structure provides continuous lateral support to rear viewing region 42. Rear viewing region 42 terminates along rear portion 36 in close proximity to inlet 46 of HVAC system 30.

HVAC system 30 includes a conduit 48 having a louvered inlet 46 positioned along an upper portion of the conduit, with inlet 46 positioned beneath, but in close proximity to rear viewing region 42. As further shown in FIGS. 2-3, conduit 48 is positioned substantially centered along the rear portion 36 of the cab behind the operator. Conduit 48 includes a filter 66 in close proximity to inlet 46, an air moving device 52, such as a fan, near the filter, as well as heat exchangers 68, 70, corresponding to respective condenser and evaporator coils of the HVAC system to condition the air to provide operator comfort.

As further shown in FIGS. 2-4, conduit 48 further extends to bifurcated portions 62 that extend along opposite sides of cab 20. Each bifurcated portion 62 of conduit 48 further extends to forward portion 32 of cab 20 having a forward cab structure 72 that supports forward viewing region 34. Each of the bifurcated portions 62 further includes a plurality of outlets 50 formed in the bifurcated portions located in close proximity to the forward portion 32. At least one outlet of the plurality of outlets 50 includes directionally adjustable louvers 64 to selectably control the direction of airflow from the outlet(s). As shown in FIG. 2, which corresponds to the right-hand portion of cab 20 from the perspective of an operator seated in the cab (the left-hand portion of the cab being symmetric to the right-hand portion), the plurality of outlets 50 is located near forward portion 32 and beneath side viewing regions 58 in substantial vertical alignment with an operator chair 74. As further shown in FIG. 3, the plurality of outlets 50 includes three outlets, generating initial respective airflows 54a, 54b, 54c that collectively define a circulating airflow 54 that flows from the plurality of outlets toward inlet 46.

FIGS. 2-3 further show exterior ambient airflow 76 exterior of cab 20 enters inlet 78, is directed via a tube 80 to a baffle 84 prior to entering chamber 31. Once interior recirculated airflow 54 and ambient airflow 78 are mixed together in chamber 31, becoming combined or mixed airflow 86, the combined or mixed airflow 86 is desirably, but not by way of limitation, directed substantially vertically along a vertical axis 87 through outlets 82 including a filter 66 prior to circulation in the operator 20 by air moving device 52. Chamber 31 is desirably at least 95 percent contained within the cab 20. As shown in FIG. 3, filter 66 is desirably positioned beneath chamber 31, although the filter may be arranged differently in other embodiments. By virtue of the arrangement of inlets 46, 76 and air moving device 52 associated with the outlet of chamber 31, the flow of air 76 exterior of the cab and the flow of recirculated air 54 from within the cab are maintainable at a predetermined ratio, enhancing operator comfort. The terms “substantial” and/or “substantially” as used herein relative to a vertical and/or horizontal orientation means plus or minus 30 degrees from the stated orientation or position. For example, a vertical orientation or position may vary by plus or minus 30 degrees; a horizontal orientation or position may also vary by plus or minus 30 degrees. The term “about” as used herein, means plus or minus 5 percent of the stated range.

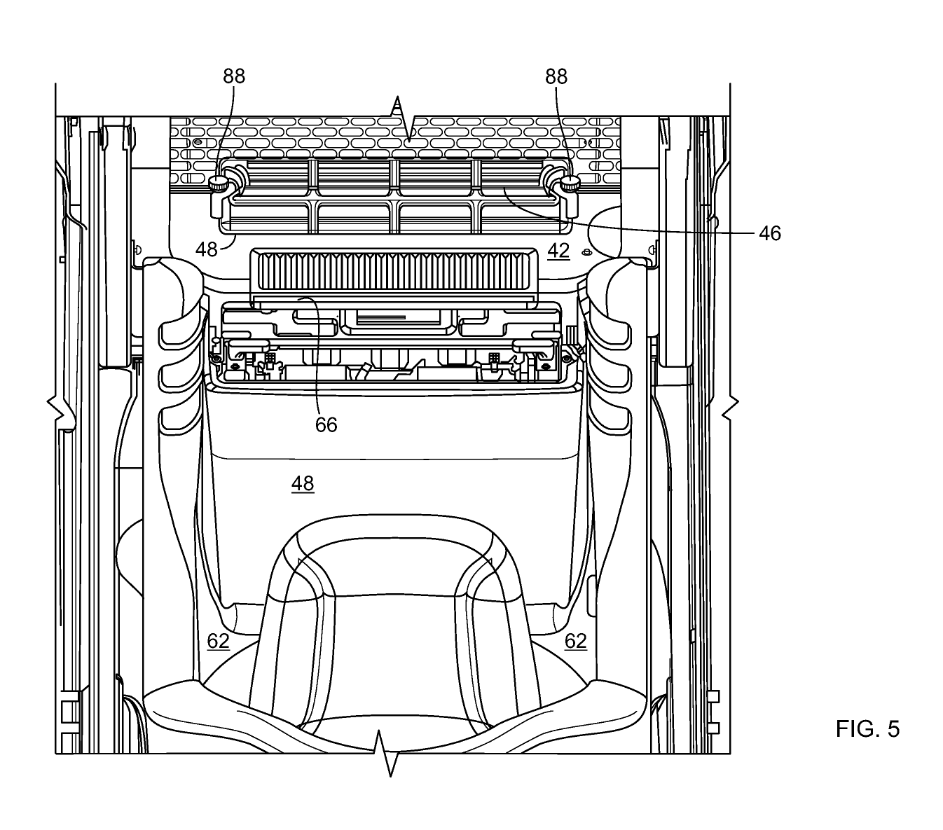

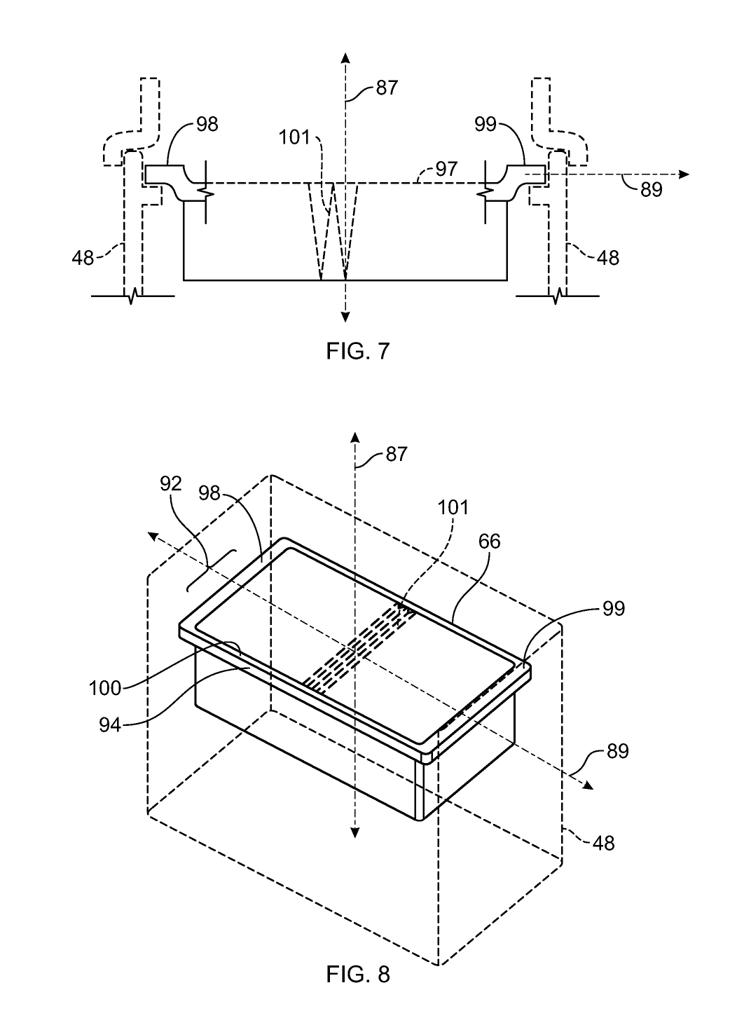

As further shown in FIGS. 3-6, inlet 46 and inlet 78 (FIG. 3) of conduit 48 are substantially vertically aligned with an operator's head, when the operator is in a seated working position interior of cab (see FIG. 2). In this location, upon removal of a portion of conduit 48 that is conveniently within reach of maintenance personnel, filter 66 can be accessed from inside cab 20. That is, filter 66 can be accessed while standing inside cab 20 or kneeling in operator chair 74 (FIG. 2). As shown in FIG. 3, the flow of air 78 exterior of cab 20 and the flow of recirculated air 54 from within the cab are each downwardly directed through the filter. As further shown in the figures, filter 66 is most desirably oriented in a substantially horizontal position with respect to the substantially vertical mixed airflow 86 which moves out of chamber 31 to filter 66, permitting removal of the filter from cab 20 substantially without spilling particles trapped by the filter. Filter 66, as shown schematically in FIGS. 3, 7 and 8, includes a horizontal axis 89 extending desirably through a center section 92 thereof. In an alternative embodiment, filter 66 may be oriented at an angle relative to vertical axis 87 and substantially vertical mixed airflow 86. That is, a first longitudinal side 94 of filter 66 may be oriented higher or lower than a second longitudinal side 95. Filter 66 also includes opposite short ends 98, 99.

It will be understood that short ends 98, 99 may also be moved upward or downward (not shown) relative to horizontal axis 87 as well. Even when filter 66 is provided at any angle described and/or illustrated herein, it will be understood that filter 66 provides the ability to trap debris all debris on or in filter 66 so that filter is easily removed by operator in a generally horizontal position so that no debris falls from filter to clog air moving device 52 and/or any portion of the HVAC system 30.

Conduit 48 substantially surrounds an outer perimeter 100 of filter 66. Filter upper surface 96 desirably, but not by way of limitation, includes pleats, or accordion folds 101, which are positioned generally horizontally, and they are desirably, but not by way of limitation, positioned at a 90 degree angle relative to horizontal axis 89. Other surface patterns of filter 66 may also be used, however, surface patterns desirably include concavities and convexities. Filter 66 may include one or more layers of filter material which desirably filters debris such as dust, dirt, ash, and other particulate material, including grass, leaves, and so forth, which desirably are held on the upper surface 96 and/or in the upper layer(s) of filter 66 so that such debris (not shown) is not passed through filter 66 to clog or disrupt the operation of air moving device 52 or any other portion of HVAC system 30. The orientation of filter 66 is desirably such that debris in mixed airflow 86 is retained on or in upper layers of filter 66 such that when filter 66 is lifted out of conduit 48, no debris readily falls into conduit 48 or into cab 20, to cause contamination of the HVAC system 30 or components thereof, or recirculating airflow 54.

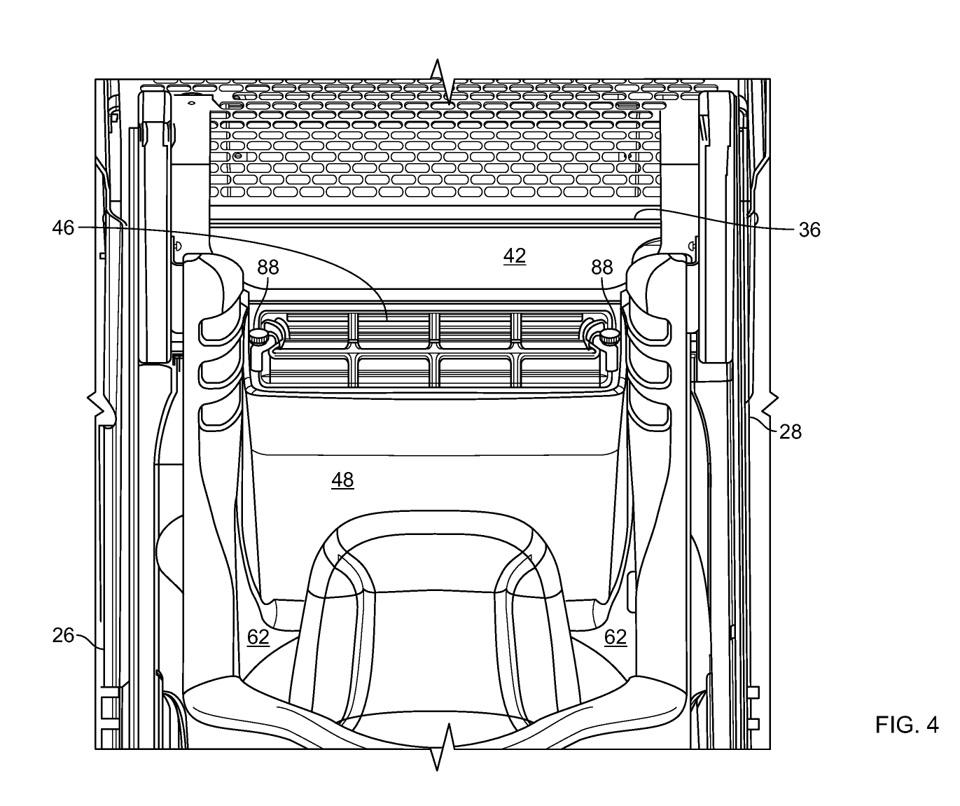

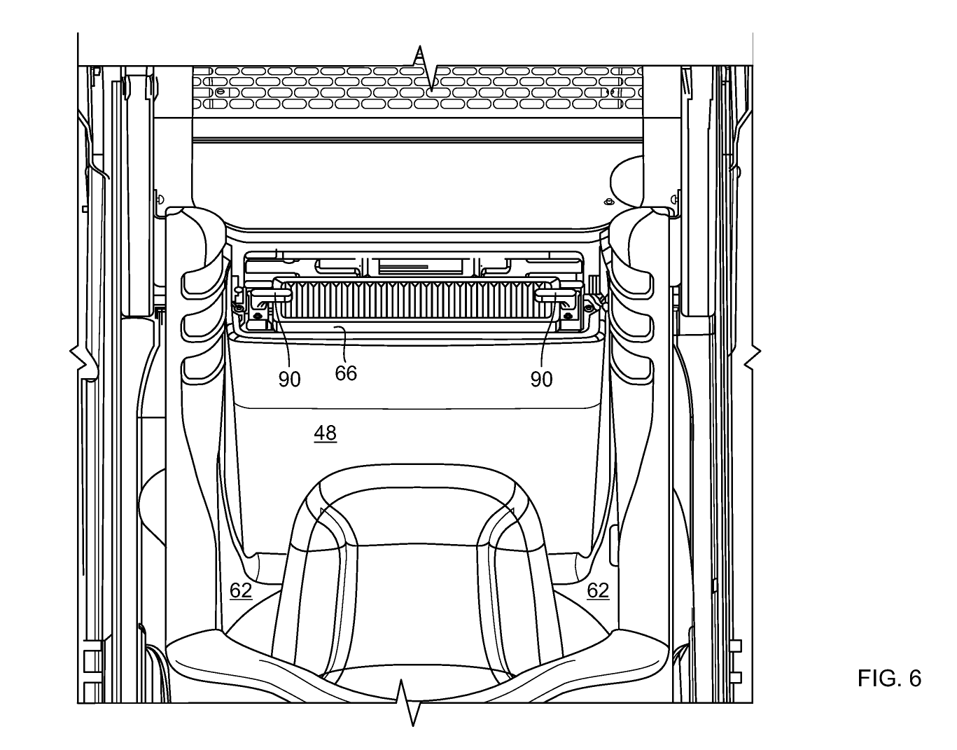

Additionally, a sufficient portion of conduit 48, which includes inlet 78, permits manual removal of filter 66. To that end, conduit 48 may include tabs, lip(s), or other devices such that filter 66 is held in positioned and unable to be inadvertently easily rotated into a vertical position by operator during removal (not shown). As further shown in FIGS. 4-6, conduit 48, which includes inlet 78, comprises a pair of manually removable connectors 88, such as a quick release connector, such as a quarter turn connector, although other connectors or fasteners may be used. As further shown in FIG. 6, in which a portion of conduit 48 that includes inlet 46 is removed for clarity, a pair of retainers 90 secures filter 66 prior to installation of inlet 46.

The interior airflow flow in a circular pattern, as illustrated in FIG. 2, which, for the purpose of the illustration, is a clockwise airflow. The filter 66 and all components of the HVAC system are in a gaseous fluid communication (“fluid communication”).

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An HVAC system for a work vehicle having an operator cab comprising:
a system positioned substantially within the cab behind and below an operator's chair, a portion of the system having at least one inlet, and a plurality of outlets positioned in front of the operator's chair, the system including
a chamber positioned in the interior of the cab and behind an operator's chair, the chamber having a first inlet for receiving an exterior airflow from outside of the cab, the chamber having a second inlet for receiving an interior recirculated airflow from air contained within the cab, the chamber mixing the exterior airflow with the interior recirculated airflow to form a mixed airflow which is directed substantially vertically downward out of a chamber outlet;
a filter positioned in a conduit connected to the chamber outlet and in fluid communication with the chamber, the first inlet, the second inlet, and the plurality of outlets, the filter positioned below the chamber in a substantially horizontal position relative to the substantially mixed airflow flowing through the chamber to an upper surface of the filter, the substantially vertical mixed airflow moving through the filter and through the plurality of outlets in the HVAC system such that airflow from the plurality of outlets circulates over and around the operator's chair, providing a generally circular path of airflow about the operator's chair, at least a portion of the circular airflow re-entering the chamber as interior recirculated airflow,
wherein the filter is configured to trap debris from the vertical mixed airflow via its orientation and the filter is configured for easy removal by an operator inside of the cab, and
wherein the filter is configured to be easily maintained in its substantially horizontal position during removal so that debris retained on the upper surface of the filter does not fall into a portion of the HVAC system or the cab when the filter is removed therefrom.

2. The HVAC system of claim 1, wherein a sufficient portion of the chamber is manually removable to permit removal of the filter.

3. The HVAC system of claim 3, wherein the chamber comprises a manually removable connector.

4. The HVAC system of claim 3, wherein the manually removable connector is a quick release connector.

5. The HVAC system of claim 4, wherein the quick release connector is a quarter turn connector.

6. The HVAC system of claim 1, wherein the first inlet and the second inlet are substantially vertically aligned with an operator's head, when the operator is in a seated working position interior of the cab.

7. The HVAC system of claim 1, wherein the exterior airflow from outside of the cab and the interior recirculated airflow from within the cab are maintainable at a predetermined ratio.

8. A work vehicle comprising:
a motor secured to a frame for activating a driving device for selectably moving the frame;
an operator cab supported by the frame;
an HVAC system for a work vehicle having an operator cab comprising:
a system positioned substantially within the cab behind and below an operator's chair, a portion of the system having at least one inlet, and a plurality of outlets positioned in front of the operator's chair, the system including
a chamber positioned in the interior of the cab and behind an operator's chair, the chamber having a first inlet for receiving an exterior airflow from outside of the cab, the chamber having a second inlet for receiving an interior recirculated airflow from air contained within the cab, the chamber mixing the exterior airflow with the interior recirculated airflow to form a mixed airflow which is directed substantially vertically downward out of a chamber outlet;
a filter positioned in a conduit connected to the chamber outlet and in fluid communication with the chamber, the first inlet, the second inlet, and the plurality of outlets, the filter positioned below the chamber in a substantially horizontal position relative to the substantially mixed airflow flowing through the chamber to an upper surface of the filter, the substantially vertical mixed airflow moving through the filter and through the plurality of outlets in the HVAC system such that airflow from the plurality of outlets circulates over and around the operator's chair, providing a generally circular path of airflow about the operator's chair, at least a portion of the circular airflow re-entering the chamber as interior recirculated airflow,
wherein the filter is configured to trap debris from the vertical mixed airflow via its orientation and the filter is configured for easy removal by an operator inside of the cab, and
wherein the filter is configured to be easily maintained in its substantially horizontal position during removal so that debris retained on the upper surface of the filter does not fall into a portion of the HVAC system or the cab when the filter is removed therefrom.

9. The work vehicle of claim 8, wherein the filter is removable from the cab substantially without spilling particles trapped by the filter.

10. The work vehicle of claim 8, wherein a sufficient portion of the chamber is manually removable to permit removal of the filter.

11. The work vehicle of claim 10, wherein the chamber comprises a manually removable connector.

12. The work vehicle of claim 11, wherein the manually removable connector is a quick release connector.

13. The work vehicle of claim 8, wherein the first inlet and the second inlet are substantially vertically aligned with an operator's head, when the operator is in a seated working position interior of the cab.

14. The work vehicle of claim 11, wherein the exterior airflow from outside of the cab and the interior recirculated airflow from within the cab are maintainable at a predetermined ratio.

15. A work vehicle comprising:
a motor secured to a frame for activating a driving device for selectably moving the frame;
an operator cab supported by the frame;
an HVAC system for a work vehicle having an operator cab comprising:
a system positioned substantially within the cab behind and below an operator's chair, a portion of the system having at least one inlet, and a plurality of outlets positioned in front of the operator's chair, the system including
a chamber positioned in the interior of the cab and behind an operator's chair, the chamber having a first inlet for receiving an exterior airflow from outside of the cab, the chamber having a second inlet for receiving an interior recirculated airflow from air contained within the cab, the chamber mixing the exterior airflow with the interior recirculated airflow to form a mixed airflow which is directed substantially vertically downward out of a chamber outlet;
a filter positioned in a conduit connected to the chamber outlet and in fluid communication with the chamber, the first inlet, the second inlet, and the plurality of outlets, the filter positioned below the chamber in a substantially horizontal position relative to the substantially mixed airflow flowing through the chamber to an upper surface of the filter, the substantially vertical mixed airflow moving through the filter and through the plurality of outlets in the HVAC system such that airflow from the plurality of outlets circulates over and around the operator's chair, providing a generally circular path of airflow about the operator's chair, at least a portion of the circular airflow re-entering the chamber as interior recirculated airflow,
wherein the filter is configured to trap debris from the vertical mixed airflow via its orientation and the filter is configured for easy removal by an operator inside of the cab,
wherein the filter is configured to be easily maintained in its substantially horizontal position during removal so that debris retained on the upper surface of the filter does not fall into a portion of the HVAC system or the cab when the filter is removed therefrom, and
wherein a sufficient portion of the chamber is manually removable to permit removal of the filter.

16. The work vehicle of claim 15, wherein the chamber comprises a manually removable connector.

17. The work vehicle of claim 16, wherein the manually removable connector is a quick release connector.

18. The work vehicle of claim 17, wherein the quick release connector is a quarter turn connector.

19. The HVAC system of claim 15, wherein the first inlet and the second inlet are substantially vertically aligned with an operator's head, when the operator is in a seated working position interior of the cab.

20. The HVAC system of claim 15, wherein the exterior airflow from outside of the cab and the interior recirculated airflow from within the cab are maintainable at a predetermined ratio.
